(19) United States
(12) Patent Application Publication
(10) Pub. No.: US 2008/0121070 A1
(43) Pub. Date: May 29, 2008

(54) Axle and axle components and method of manufacturing

(76) Inventors: James A. Krisher, Fort Wayne, IN (US); Zachary M. Heisey, Maumee, OH (US)

Correspondence Address: BERENATO, WHITE & STAVISH, 6550 ROCK SPRING DRIVE, SUITE 240, BETHESDA, MD, 20817, US

(21) Appl. No.: 11/510,646

(22) Filed: Aug. 28, 2006

(51) Int. Cl. B60B 35/00; B60B 27/00; B23P 15/00; B23P 11/00

(52) U.S. Cl. 74/607; 301/111.04; 29/525.01

(57) ABSTRACT

An axle housing assembly for a motor vehicle comprises a hollow, elongated arm section extending along a center axis and a wheelend. The wheelend is fixed to an outboard end portion of the arm section. The wheelend includes a wheelend adapter fixed to the outboard end of the arm section so as to extend radially outwardly therefrom, a tubular spindle member extending axially outwardly from the wheelend adapter substantially along the center axis, and a brake backer plate attached to the wheelend adapter. The spindle member has a substantially cylindrical bearing support surface for supporting an axle bearing.

### BACKGROUND OF THE INVENTION

1. Field of the Invention

This invention pertains to vehicle axles and their components and methods of manufacturing vehicle axles and components.

2. Background

Drive axle assemblies are well known structures that are in common use in most vehicles. Such axle assemblies include a number of components, which are adapted to transmit rotational power from an engine of the vehicle to the wheels thereof. Typically, an axle assembly includes a differential assembly that is rotatably supported within a non-rotating carrier. The differential is connected between an input drive shaft extending from the vehicle engine and a pair of output axle shafts extending to the vehicle wheels. The axle shafts are contained in respective non-rotating beam sections, which are secured to the carrier. Thus, rotation of the differential by the drive shaft causes corresponding rotation of the axle shafts. The carrier and the beam sections form an axle housing assembly for these drive train components of the axle assembly, inasmuch as the differential and the axle shafts are supported for rotation therein.

One of the most common types of the axle housing assemblies used in the art is banjo type axle housing. Banjo type axle housings are advantageous because the carrier and differential can be removed from the axle assembly for service without disturbing the other components thereof. The most common method for manufacturing the banjo type axle housings involves forming two opposite halves of the axle housing by stamping or forging from a pre-cut blank of sheet steel. Next, the two axle housing halves are welded along mated horizontal edges, and then the axle assembly is completed in a known manner. The above method for manufacturing the banjo type axle housings is relatively simple and efficient. However, tooling used for stamping the axle housing halves is very expensive. Moreover, when a number of axle housings of various sizes are produced, a corresponding number of different metal forming apparatuses has to be employed that requires rather large tooling expenses.

Furthermore, the banjo housings (especially larger ones) typically have square or rectangular cross-section for beaming strength, thus necessitating transitioning to round outboard end for accommodating a generally cylindrical wheelend unit. The round cross-section accommodates existing brake designs for attachment. Moreover, this design cannot easily accommodate tread width changes, or lateral repositioning of a driving head for propeller shaft relocation. Moreover, when a number of axle housings of various sizes are produced, a corresponding number of different metal forming apparatuses has to be employed that requires rather large tooling expenses.

Therefore, the drive axle housing assemblies of the prior art and methods for manufacturing thereof, including but not limited to those discussed above, are susceptible to improvements that may enhance their performance and cost. With this in mind, a need exists to develop an improved drive axle housing assembly and a method for manufacturing thereof that advances the art.

### SUMMARY OF THE INVENTION

The present invention provides an improved axle housing assembly for a motor vehicle that accommodates both semi-float and full-float drive axle housing assemblies, and a method for manufacturing thereof.

The axle housing assembly in accordance with the preferred embodiments of the present invention comprises a hollow, elongated arm section extending along a center axis and a wheelend. The wheelend is fixed to an outboard end portion of the arm section. The wheelend includes an adapter plate member fixed to the outboard end of the arm section so as to extend radially outwardly therefrom, a spindle member extending axially outwardly from the adapter plate member substantially along the center axis, and a brake backer plate attached to the adapter plate. The spindle member has a substantially cylindrical bearing support surface for supporting an axle bearing.

The method for manufacturing a banjo-type axle housing assembly in accordance with the present invention comprises the following steps. First, a desired length of the axle housing is selected. Then, the axle housing is produced that has a length larger than the desired length. Subsequently, outboard end portions of the axle arm sections of the axle housing are selectively trimmed to achieve said desired length.

Therefore, the present invention allows a single wheelend to be used with the axle assemblies of various cross-sections. In case of the axle housing assemblies having generally rectangular cross-sections of the axle arm sections, the present invention allows to eliminate the transition to round. Also, the present invention facilitates installing full and semi-float wheelends to common banjo housing design. The present invention also allows accommodating existing brake mechanisms and bearing assemblies into large banjo-type drive axle housings. By integrating the bearing housing with the brake caliper mounting brake backer plate, one part can be eliminated. Thus, the present invention reduces cost, complexity and weight of the axle housing assembly. The novel method for manufacturing a banjo-type axle housing assembly of the present invention allows easily modify tread width and pinion lateral locations on the motor vehicle while using a common banjo housing design.

### BRIEF DESCRIPTION OF THE DRAWINGS

Other objects and advantages of the invention will become apparent from a study of the following specification when viewed in light of the accompanying drawings, wherein:

FIG. 1 is a partial cross-sectional view of a drive axle for a motor vehicle including a wheelend adapter according to a first exemplary embodiment of the present invention;

FIG. 2 is a perspective view of a banjo type axle housing without wheelend units;

FIG. 3 is a cross-sectional view of an outboard end portion of an arm section of the axle housing assembly taken along the plane 3-3 of FIG. 2;

FIG. 4 is a front view of the banjo type axle housing before trimming operation;

FIG. 5 is a partial exploded cross-sectional view of a wheelend unit of the axle according to the first exemplary embodiment of the present invention;

FIG. 6 is a cross-sectional view of a spindle member of the wheelend adapter according to the first exemplary embodiment of the present invention;

FIG. 7 is a front view of the wheelend adapter according to the first exemplary embodiment of the present invention;

FIG. 8 is a partial cross-sectional view of a axle for a motor vehicle according to a second exemplary embodiment of the present invention;

FIG. 9 is a cross-sectional view of a wheelend adapter according to the second exemplary embodiment of the present invention;

FIG. 10 is a front view of the wheelend adapter according to the second exemplary embodiment of the present invention;

FIG. 11 is a rear view of the wheelend adapter according to the second exemplary embodiment of the present invention.

### DESCRIPTION OF THE PREFERRED EMBODIMENTS

The preferred embodiments of the present invention will now be described with the reference to accompanying drawing.

For purposes of the following description, certain terminology is used in the following description for convenience only and is not limiting. The words such as “inboard”, “outboard”, “inwardly” and “outwardly” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

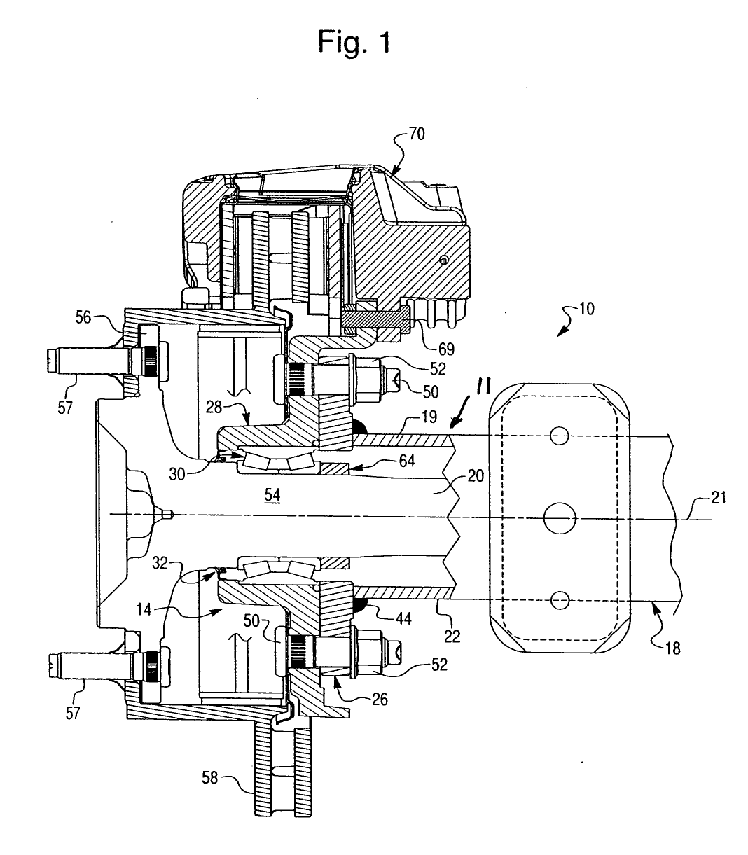

Referring to FIGS. 1-6 of the drawings, a first exemplary embodiment of a drive axle of the present invention, generally denoted by reference numeral 10, for use in a conventional motor vehicle, is illustrated. The drive axle 10 is in the form of a semi-float axle and comprises a banjo-type axle housing assembly 11 including a banjo-type axle housing 12 and a pair of opposite semi-float wheelend units (or wheelends) 14 mounted at the opposite ends of the axle housing 12.

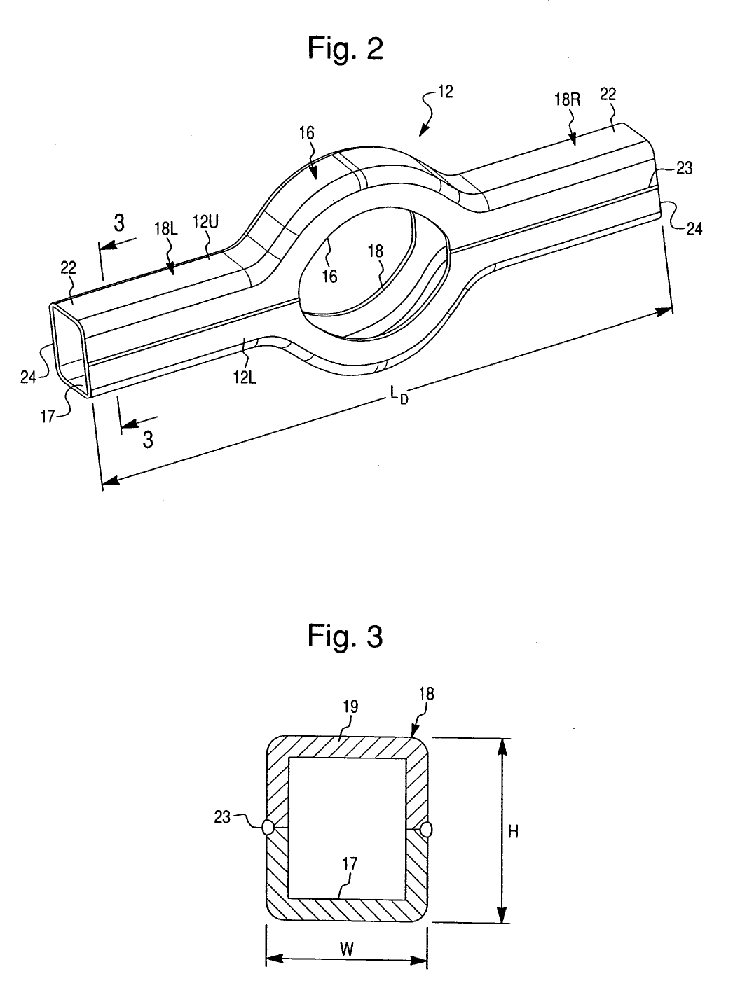

The axle housing 12 of the present invention, illustrated in detail in FIG. 2, includes an enlarged central, or banjo, section 16 defining a hollow interior adapted for housing a differential assembly (not shown) therein, and a pair of hollow, sleeve-like elongated right and left axle beam (or arm) sections 18R and 18L, respectively, (referred to in general as “arm sections 18”) outwardly laterally extending from opposite sides of the center section 16 for housing axle shafts (generally denoted by reference numeral 20 in FIG. 1). The axle shafts 20 is supported within a wall 19 defining the arm sections 18R and 18L of the axle housing 12 by for rotation about a center axis 21.

As further illustrated in FIG. 1, each of the wheelend units 14 is mounted to an outboard end portion 22 of each of the corresponding arm sections 18 of the axle housing 12. The arm sections 18 of the axle housing 12, including the outboard end portions 22 thereof, are generally rectangular in cross-section, as illustrated in FIGS. 2 and 3. As illustrated in FIG. 3, the rectangular cross-section of each of the axle arm sections 18, known as a box-section in the art, is characterized by dimensions H (a height of the box-section) and W (a width of the box-section). The box-section of the axle arm sections 18 need to be selected to withstand torsional and vertical load to the axle housing 12, and load fluctuations. It will be appreciated that any non-circular cross-section of the end portion of the axle housing 12 is within the scope of the present invention. Each of the end portions 22 of the axle housing 12 has a substantially planar end face 24 oriented substantially perpendicularly to the center axis 21 and an inner peripheral surface 17 adjacent to the end face 24. While the present invention is described in relation to the axle housing assembly having the outboard end portions of generally non-circular cross-section, it is to be understood that the present invention is equally suitable for use in the axle housing assembly having the outboard end portions of generally circular cross-section.

Referring again to FIG. 1, each of the wheelend units 14 comprises a wheelend adapter 26 secured to the outboard end portion 22 of the axle housing 12, a tubular spindle member 28 carrying an antifriction bearing assembly (or bearing) 30, a brake backer plate 48 extending radially outwardly from the spindle member 28, and a lip seal 32 which isolates an interior of the axle housing 12. The antifriction bearing assembly 30 is provided for rotatably supporting the axle shaft 20 about the center axis 21 within the arm section 18 of the axle housing 12.

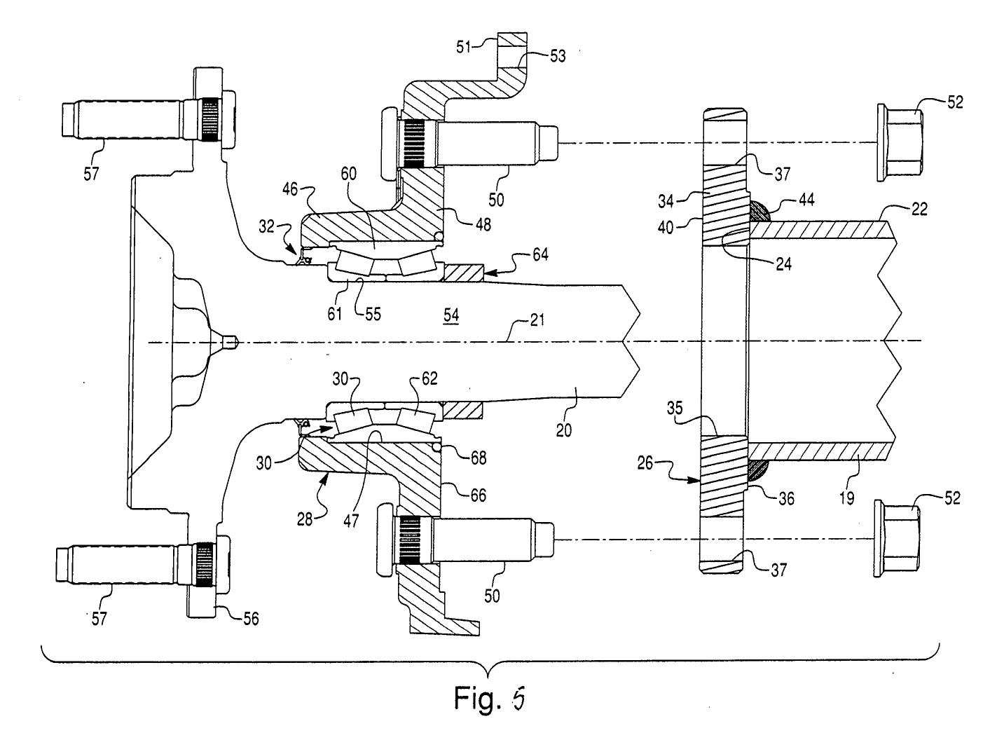

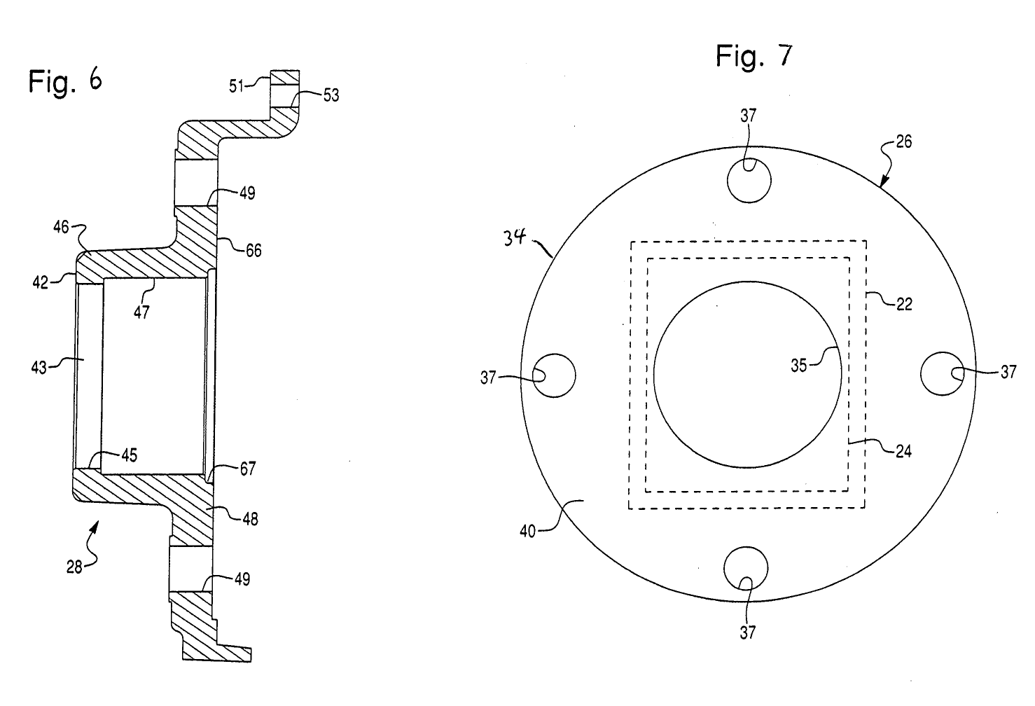

As illustrated in detail in FIGS. 5 and 7, the wheelend adapter 26 includes an adapter plate member 34 secured to the outboard end portion 22 of the axle housing 12. Preferably, the adapter plate member 34 is in the form of a plate having an inboard face 36, and an outboard face 40. Further preferably, the adapter plate member 34 is annular in shape and has a central opening 35 therethrough, as shown in FIG. 6. The adapter plate member 34 of the wheelend adapter 26 is secured to the outboard end portion 22 of the corresponding arm section 18 of the axle housing 12 so as to extend radially outwardly therefrom. Preferably, the adapter plate member 34 is fixed to the outboard end portion 22 of the corresponding arm section 18 substantially coaxially to the center axis 21 and is oriented substantially perpendicularly to the center axis 21. Further preferably, the adapter plate member 34 is fixed to the outboard end portion 22 of the arm section 18 by welding, as indicated at 44, so that the inboard face 36 of the adapter plate member 34 engages the end face 24 of the outboard end portion 22 of the arm section 18 of the axle housing 12. It will be appreciated that the adapter plate member 34 may be secured to the outboard end portion 22 in any other appropriate manner known in the art, such as adhesive bonding, using threaded fasteners, etc. Moreover, as further shown in FIGS. 1 and 5, the adapter plate member 34 is fixed to the outboard end portion 22 of the arm section 18 so as to slightly extend radially inwardly from the wall 19 of the arm section 18. It is to be understood that the phantom lines in FIG. 5 denote the end face 24 of the outboard end portions 22 of the axle housing 12.

As illustrated in detail in FIGS. 5 and 6, the spindle member 28 includes a bearing cup (or bearing retaining housing) 46 extending axially outwardly from the adapter plate member 34 substantially along the center axis 21 and formed integrally with the brake backer plate 48 extending radially outwardly from the bearing cup 46. The bearing cup 46 is provided with a retainer flange 42 having an opening 43 therethrough defined by a substantially cylindrical inner peripheral surface 45 receiving the lip seal 32. The inner peripheral surface 45 is oriented substantially coaxially to the center axis 21. Preferably, the spindle member 28 is formed as a homogenous, unitary single-piece part.

The bearing cup 46 has a substantially cylindrical bearing support surface 47 for supporting the antifriction bearing assembly 30. The bearing support surface 47 is oriented substantially coaxially to the center axis 21. The wheelend spindle member 28 is securely attached to the adapter 26 by means of threaded studs 50 and complementary nuts 52 so that the threaded studs 50 extend through corresponding holes 37 and 49 in the adapter plate member 34 of the wheelend adapter 26 and the backer plate 48 of the spindle member 28, respectively. It will be appreciated that the spindle member 28 may be secured to the adapter plate member 34 by any other appropriate means known in the art, such as welding, adhesive bonding, etc. More specifically, the wheelend spindle member 28 is attached to the adapter 26 so that an inboard face 66 of the brake backer plate 48 of the spindle member 28 engages the outboard face 40 of the wheelend adapter 26. Moreover, as further illustrated in FIG. 1, the spindle member 28 sealingly engages the wheelend adapter 26 through a sealing member 68. The sealing member 68 is disposed in a circular groove 67 formed in the inboard face 66 of the brake backer plate 48 adjacent to the bearing support surface 47 of the spindle member 28, as shown in FIGS. 5 and 7.

Furthermore, the brake backer plate 48 of the spindle member 28 is provided to support a wheel brake mechanism, such as a brake caliper 70. More specifically, the brake caliper 68 is non-rotatably coupled to the brake backer plate 48 by means of threaded fasteners 69 extending through corresponding threaded holes 53 in a brake flange 51 integrally formed with the backer plate 48 of the spindle member 28. It will be appreciated that the brake caliper 70 may be secured to the brake backer plate 48 of the spindle member 28 by any other appropriate means known in the art, such as welding, adhesive bonding, etc. As further shown in FIGS. 1 and 5, the axle shaft 20 has an enlarged cylindrical bearing seat portion 54 in the region of the spindle member 28 and a drive flange 56. The drive flange 56 is provided with threaded studs 57 for securing to the axle shaft 20 a vehicle wheel (not shown) and a brake disk rotor 58.

Preferably, the anti-friction bearing assembly 30 is in the form of a double row tapered roller bearing and includes an outer race 60, an inner race 61, and bearing rollers 62 located between the outer race 60 and the inner race 61. In an assembled condition, as illustrated in FIG. 1, the outer race 60 is snugly fit onto the bearing support surface 47 of the bearing cup 46 and is sandwiched between the retainer flange 42 of the bearing cup 46 and the outboard face 40 of the wheelend adapter 26. The inner race 61 of the antifriction bearing assembly 30, on the other hand, is mounted over the bearing seat portion 54 of the axle shaft 20 and is tightly held in place on the bearing seat portion 54 of the axle shaft 20 by a retention ring 64. In turn, the retention ring 64 is secured to axle shaft 20 by an interference fit on the bearing seat portion 54 of the axle shaft 20. It will be appreciated that any other means of fixing the retention ring 64 on the axle shaft 20, such welding, threaded engagement, adhesive bonding, etc., is within the scope of the present invention. Alternatively, the retention ring 64 press-fit over the bearing seat portion 54 of the axle shaft 20 may be replaced with a retention C-ring received in a complementary groove formed in the bearing seat portion 54 of the axle shaft 20.

The method of assembling the drive axle 10 according to the first exemplary embodiment of the present invention is performed in the following manner.

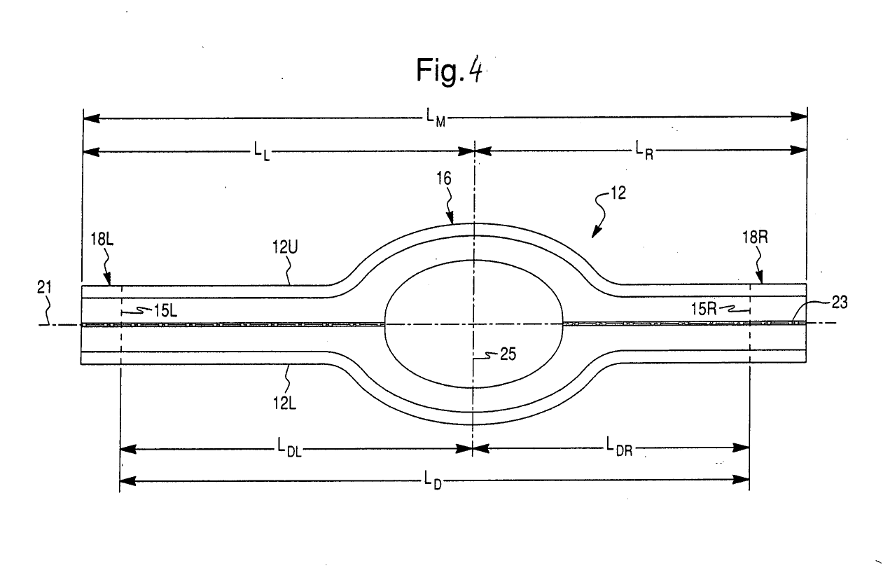

First, as illustrated in FIG. 4, the adapter plate member 34 of the wheelend adapter 26 is fixed to the outboard end portion 22 of the arm section 18 of the axle housing 12 substantially coaxially to the center axis 21 by welding along mating edges, as indicated at 44, so that the inboard face 36 of the adapter plate member 34 engages the end face 24 of the axle housing 12. Then, the lip seal 32 is mounted to the cylindrical inner peripheral surface 45 of the retainer flange 42 of the bearing cup 46 of the spindle member 28 by an interference fit (press-fit). After that, the antifriction bearing 30 is mounted to the bearing seat portion 54 of the axle shaft 20 between the axle shaft 20 and the bearing cup 46 of the spindle member 28. Then, the retention ring 64 is secured to the bearing seat portion 54 of the axle shaft 20 by an interference fit.

Next, the axle shaft 20 is inserted into the central opening 35 in the adapter plate member 34 of the wheelend adapter 26 so that the inboard face 66 of the brake backer plate 48 of the spindle member 28 engages the outboard face 40 of the adapter plate member 34 of the wheelend adapter 26. Subsequently, the spindle member 28 is non-rotatably secured to the wheelend adapter 26 by firmly coupling the backer plate 48 of the spindle member 28 to the adapter plate member 34 of the wheelend adapter 26 with the threaded fasteners 50, 52. Subsequently, the brake caliper 70 is coupled to the brake backer plate 48 of the spindle member 28 with the threaded fasteners 69.

The novel wheelend unit including a wheelend adapter of the present invention allows easily modify a tread width on the motor vehicle by manufacturing the axle housing wider than typically required, then trimming axle arm sections of the axle housing assembly to desired length. In other words, the present invention facilitates multiple tread widths and pinion lateral locations while using a common banjo housing design.

Thus, the present invention is also directed to a method for manufacturing a range of banjo-type axle housings of selective tread width (i.e. a length of the axle housing) and pinion lateral locations (i.e. a location of a pinion drive gear relative to geometric center of the axle housing in a transverse direction along the center axis 21) by manufacturing axle housings with unequal length of the arm sections thereof. The method for manufacturing the banjo-type drive axle housing assembly 11 in accordance with the present invention is performed in the following manner.

First step is the operation of forming substantially identical upper and lower channel-shaped half members 16U and 16L of the axle housing 12, as illustrated in FIGS. 2 and 4. Similarly to the conventional method for manufacturing of banjo-type axle housings described hereinabove, each of the members 16U and 16L is formed, such as by stamping or forging, from a blank sheet (not shown), and has a substantially U-shaped cross-section along entire length thereof. Each of the upper and lower half members 16U and 16L of the axle housing fabricated during the first step of the method according to the present invention, has an original length L_{M} in the direction of the center axis 21 corresponding to a largest required length of the axle arm sections of the axle housing for a particular category of the motor vehicle, as illustrated in FIG. 4. Then, the upper and lower housing half members 16U and 16L are secured to each other, preferably by welding along mating horizontal edges, as indicated at 23 in FIGS. 2, 3 and 4. Evidently, the axle housing 12 formed from the half members 16U and 16L has an overall length L_{M} in the direction of the center axis 21. Preferably, original lengths L_{L} and L_{R} of the left and right axle arm sections 18L and 18R, respectively, of the axle housing 12 are equal to each other.

As illustrated in FIG. 4, the length of the axle arm section 18 of the axle housing 12 is defined as a distance between a vertical central axis 25 and a corresponding end face of the axle arm section 18 of the axle housing 12. The central axis 25 extends through a geometric center of the central section 16 of the axle housing 12 substantially orthogonally to the center axis 21. More specifically, the length of the left axle arm section 18L—L_{L}—is defined as a distance between the central axis 25 and the end face of the left axle arm section 18L. Similarly, the length of the right axle arm section 18R—L_{R}—is defined as a distance between the central axis 25 and the end face of the right axle arm section 18R.

Next step is to select a desired length L_{D} of the axle housing 12 (which is equal or smaller than the original length L_{M}) for a particular motor vehicle corresponding to a required thread width of the particular motor vehicle. Alternatively, desired lengths L_{DL} and L_{DR} of the left and right axle arm sections 18L and 18R, respectively, of the axle housing 12 may be selected such that correspond to a required thread width of the particular motor vehicle and a required lateral location of a pinion drive gear (not shown). In other words, the desired lengths L_{DL} and L_{DR} of the axle arm sections 18L and 18R of the axle housing 12 could be equal or different so that:

L_{DL}≧L_{DR} (as shown in FIG. 4) or L_{DL}≦L_{DR}.

It will be appreciated that a sum of the lengths L_{DL} and L_{DR} is equal or smaller than the original length L_{M}, i.e.

L_{DL}+L_{DR}≦L_{M}.

Then, if necessary, appropriate portions of the axle arm sections 18L and 18R of the axle housing 12 are selectively trimmed (or cut) by any appropriate means known in the art along a phantom lines 15L and 15R, respectively, as illustrated in FIG. 4, so as to provide the desired length L_{D} of the axle housing 12 or the desired lengths L_{DL} and L_{DR} of the axle arm sections 18L and 18R of the axle housing 12 that would ensure the required thread width of the particular motor vehicle and/or the required lateral location of the pinion drive gear of the drive axle assembly 10. It should be understood that the appropriate portions of the axle arm sections 18L and 18R of the axle housing 12 are trimmed to a degree so that more than burrs or flash material is removed. As a result of the arm section trimming operation, the substantially planar end face 24 is formed at each of the end portions 22 of the axle housing 12.

Alternatively, the appropriate portions of axle arm sections of the upper and lower housing half members 16U and 16L could be trimmed separately, before assembling the axle housing 12 by welding upper and lower housing half members 16U and 16L along mating horizontal edges.

Subsequently, the wheelend units 14 are fixed (attached) to the corresponding outboard end portions 22 of the axle housing 12. More specifically, the adapter plate member 34 of the wheelend adapter 26 is fixed to the outboard end portion 22 of the arm section 18 of the axle housing 12 substantially coaxially to the center axis 21 by welding along mating edges, as indicated at 44, so that the inboard face 36 of the adapter plate member 34 engages the end face 24 of the axle housing 12.

Subsequently, the spindle member 28 is non-rotatably secured to the wheelend adapter 26 by firmly coupling the backer plate 48 of the spindle member 28 to the adapter plate member 34 of the wheelend adapter 26 with the threaded fasteners 50, 52 so that the inboard face 66 of the brake backer plate 48 of the spindle member 28 engages the outboard face 40 of the adapter plate member 34 of the wheelend adapter 26.

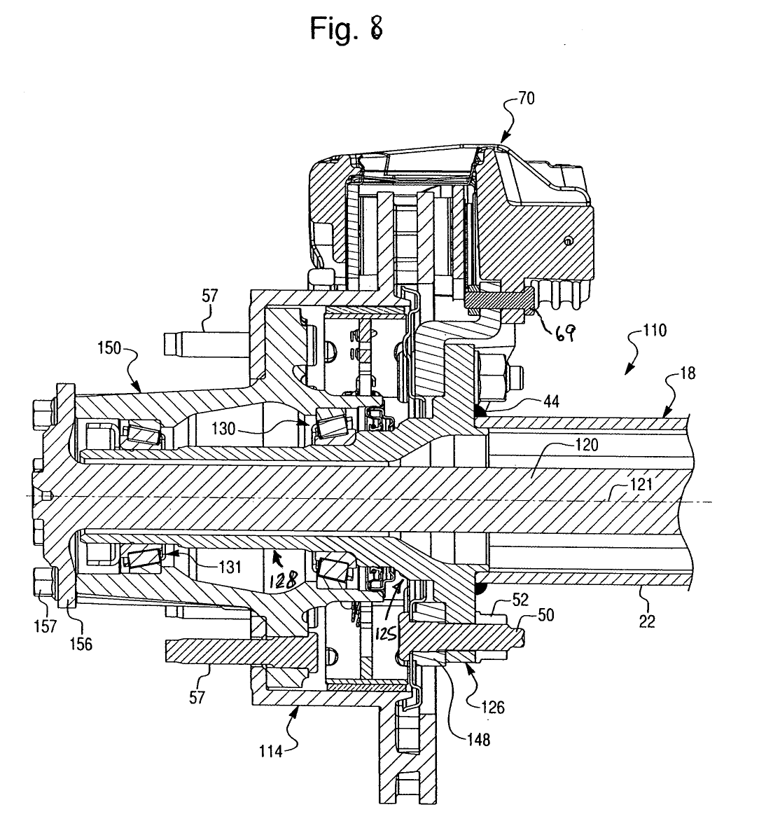

FIGS. 8-11 illustrate a drive axle 110 according to a second exemplary embodiment of the present invention. Components, which are unchanged from the first exemplary embodiment of the present invention are labeled with the same reference characters. Components, which function substantially in the same way as in the first exemplary embodiment of the present invention depicted in FIGS. 1-7, are designated by the same reference numerals to which 100 has been added, sometimes without being described in detail since similarities between the corresponding parts in the two embodiments will be readily perceived by the reader.

The drive axle 110 according to the second exemplary embodiment of the present invention is in the form of a full-float axle and comprises a banjo-type axle housing assembly 12 including a pair of opposite full-float wheelend units 114 mounted at the opposite ends of the axle housing assembly 12 (shown in FIG. 2). Each of the wheelend units 114 comprises a wheelend component 125 secured to the outboard end portion 22 of the axle housing assembly 12, and a wheel hub 150 supported on the wheelend component 125 through an antifriction axle bearing assembly including axle bearings 130 and 131 for rotation about a center axis 121 of an axle shaft 120. As further shown in FIG. 8, the axle shaft 120 has a drive flange 156 provided at an outboard end thereof. The drive flange 156 of the axle shaft 120 is fastened to the wheel hub 150 with a plurality of bolts 157. It will be appreciated that the drive flange 156 of the axle shaft 120 may be connected to the wheel hub 150 in any appropriate manner, such as by spline connection or the like.

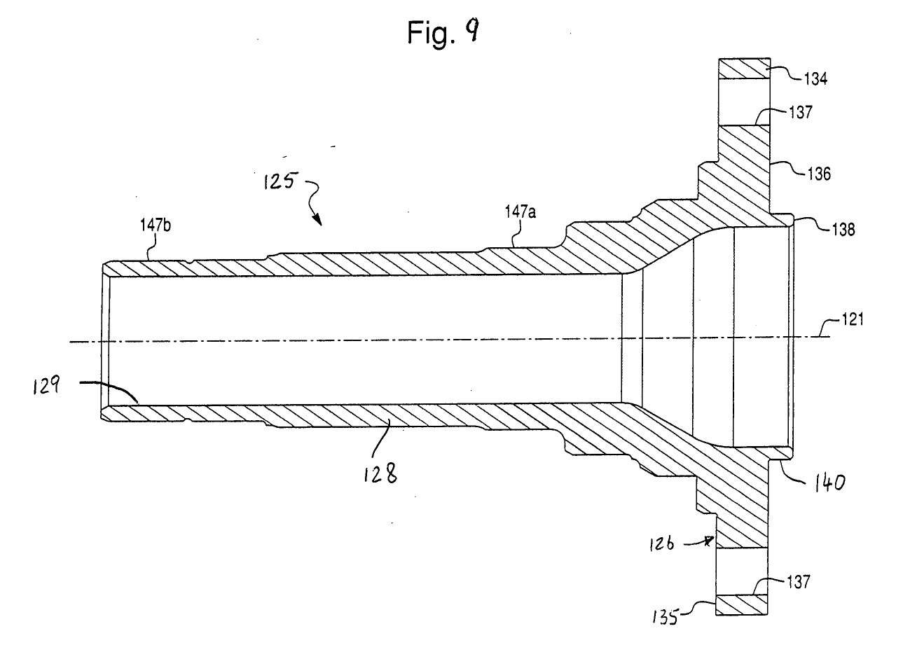

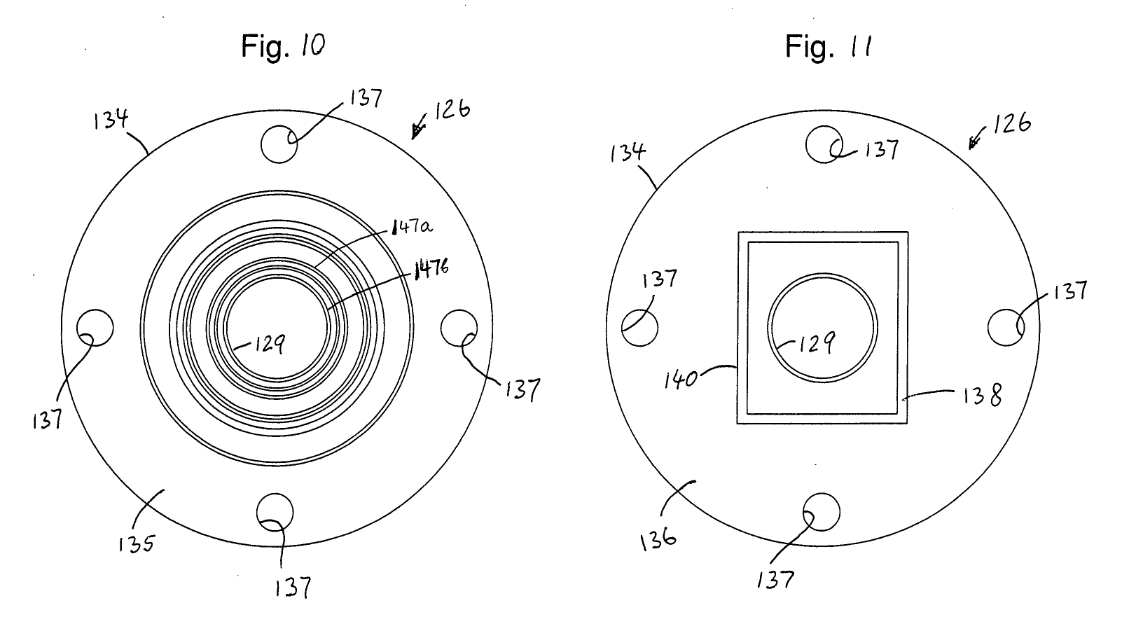

The wheelend component 125, shown in detail in FIGS. 9-11, has a central opening 129 therethrough and includes a wheelend adapter 126 and a tubular spindle member 128 extending axially outwardly from the wheelend adapter 126 substantially along the center axis 121. The wheelend adapter 126 includes an adapter plate member 134 is in the form of a plate oriented substantially perpendicularly to the center axis 121 so as to extend radially outwardly from the outboard end portion 22 of the arm section 18 of the axle housing assembly 12, and has an inboard face 135 and an inboard face 136. Preferably, the adapter plate member 134 is annular in shape, as shown in FIGS. 10 and 11. The spindle member 128 has substantially cylindrical bearing support surfaces 14a and 147b for supporting thereon the axle bearings 130 and 131, respectively. In other words, the wheel hub 150 is rotatably supported on the axle bearings 130 and 131 mounted to the spindle member 128 of the wheelend adapter 126. Preferably, the wheelend component 125 is formed as a homogenous, unitary single-piece part.

As further illustrated in detail in FIG. 9, the wheelend adapter 126 also includes an integral pilot flange 138 extending axially outwardly from the adapter plate member 134 in the direction away from the axle bearings 130 and 131 and having an outer peripheral surface 140. The pilot flange 138 of the wheelend adapter 126 is received in the end portion 22 of the arm section 18 of the axle housing assembly 12 so that the outer peripheral surface 140 of the pilot flange 138 engages the inner peripheral surface 17 of the end portions 22 of the axle housing assembly 12 for piloting and properly aligning the wheelend adapter 126 relative to the end portion 22 of the axle housing assembly 12. Such an arrangement allows the positioning of the wheelend adapter 126 coaxially relative to the center axis 121.

The wheelend adapter 126 is secured to the outboard end portion 22 of the arm section 18 of the axle housing assembly 12 so as to extend radially outwardly therefrom. Preferably, the adapter plate member 134 of the wheelend adapter 126 is fixed to the outboard end portion 22 of the arm section 18 substantially coaxially to the center axis 121 so that the adapter plate member 134 is disposed substantially perpendicularly to the center axis 121. Further preferably, the adapter plate member 134 is fixed to the outboard end portion 22 of the arm section 18 by welding, as indicated at 44 in FIG. 8, so that the inboard face 136 of the adapter plate member 134 engages the end face 24 of the axle housing assembly 12. It will be appreciated that the adapter plate member 134 may be secured to the outboard end portion 22 in any other appropriate manner known in the art, such as adhesive bonding, using threaded fasteners, etc.

Preferably, the axle bearings 130 and 131 are in the form of tapered roller bearings. Each of the axle bearings 130 and 131 includes an inner race mounted to the outer peripheral surface of the wheelend adapter 126, an outer race mounted to an inner peripheral surface of the wheel hub 150, and tapered rollers located between the outer race and the inner race.

The full-float wheelend unit 114 further includes a brake backer plate 148 attached to the adapter plate member 134 of the wheelend adapter 126. The brake backer plate 148 is securely attached to the adapter plate member 134 of the wheelend adapter 126 by means of threaded studs 50 and complementary nuts 52 so that the threaded studs 50 extend through corresponding holes 137 and 149 in the adapter plate member 134 and the backer plate 148, respectively. It will be appreciated that the brake backer plate 148 may be secured to the adapter plate member 134 of the wheelend adapter 126 by any other appropriate means known in the art, such as welding, adhesive bonding, etc. The brake backer plate 148 is provided to support a wheel brake mechanism, such as a brake caliper 70. More specifically, the brake caliper 70 is non-rotatably coupled to the brake backer plate 148 by means of threaded fasteners 69 extending through corresponding threaded holes in the backer plate 148. It will be appreciated that the brake caliper 70 may be secured to the brake backer plate 148 by any other appropriate means known in the art, such as welding, adhesive bonding, etc.

Therefore, the present invention provides a novel wheelend unit including a wheelend adapter allowing a single wheelend unit to be used with the axle assemblies of various cross-sections. The present invention allows to eliminate the transition to round in the axle housing assemblies having generally rectangular cross-sections of the axle arm sections. Also, the present invention facilitates installing full and semi-float wheelend units to a common banjo housing design. More specifically, with various flange designs at each end of the banjo housing, both semi-float and full-float wheel end concepts can be accommodated. Furthermore, the present invention allows accommodating existing brake mechanisms and bearing assemblies into large banjo-type drive axle housings. By integrating the bearing housing with the brake caliper mounting brake backer plate, one part can be eliminated. Thus, the present invention reduces cost, complexity and weight of the axle housing assembly.

The present invention also provides a novel method for manufacturing a banjo-type drive axle housing assembly that allows easily modify tread width and pinion lateral locations on the motor vehicle by manufacturing the housing wider than typically required, then selectively trimming axle arm sections of the axle housing assembly to desired length. In other words, the present invention facilitates multiple tread widths and pinion lateral locations while using a common banjo housing design.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. An axle housing assembly comprising:
a hollow, elongated arm section extending along a central axis and having an outboard end portion; and
a wheelend fixed to said outboard end portion of said arm section;
said wheelend including:
a wheelend adapter fixed to said outboard end of said arm section so as to extend radially outwardly therefrom;
a spindle member extending axially outwardly from said wheelend adapter substantially along said central axis and having a substantially cylindrical bearing support surface for supporting an axle bearing; and
a brake backer plate attached to said wheelend adapter.

2. The axle housing assembly as defined in claim 1, wherein said outboard end portion of said arm section has a non-circular cross-section.

3. The axle housing assembly as defined in claim 2, wherein said outboard end portion of said arm section has a substantially rectangular cross-section.

4. The axle housing assembly as defined in claim 1, wherein said adapter plate member is fixed to said outboard end of said arm section so that an inboard face of said wheelend adapter engages an end face of said outboard end of said arm section of said axle housing assembly.

5. The axle housing assembly as defined in claim 4, wherein said wheelend adapter further extends radially inwardly from a wall of said arm section of said axle housing assembly.

6. The axle housing assembly as defined in claim 1, wherein said spindle member is formed integrally with said brake backer plate as a homogenous, unitary single-piece part.

7. The axle housing assembly as defined in claim 1, wherein said wheelend adapter is formed integrally with said spindle member as a homogenous, unitary single-piece part.

8. The axle housing assembly as defined in claim 1, wherein said cylindrical bearing support surface is an inner peripheral surface of said spindle member; and wherein said axle bearing is mounted within said spindle member between said spindle member and an axle shaft extending through said arm section of said axle housing assembly.

9. The axle housing assembly as defined in claim 1, wherein said cylindrical bearing support surface is an outer peripheral surface of said spindle member, and wherein said axle bearing is mounted outside said spindle member between said spindle member and a wheel hub supported on said spindle member through said axle bearing for rotation about said central axis.

10. The axle housing assembly as defined in claim 1, wherein said wheelend adapter is fixed to said outboard end portion of said arm section so as to extend radially inwardly said arm section.

11. The axle housing assembly as defined in claim 1, wherein said wheelend adapter is fixed to said outboard end portion of said arm section substantially coaxially to said center axis and is oriented substantially perpendicularly to said center axis.

12. The axle housing assembly as defined in claim 1, wherein said brake backer plate is attached to said wheelend adapter by means of a plurality of threaded fasteners.

13. The axle housing assembly as defined in claim 1, further comprising a wheel brake mechanism fastened to said brake backer plate.

14. The axle housing assembly as defined in claim 1, wherein said wheelend adapter is annular in shape and has a central opening therethrough.

15. A wheelend comprising:
a wheelend adapter;
a spindle member extending axially outwardly from said wheelend adapter substantially along a central axis and having a substantially cylindrical bearing support surface for supporting an axle bearing; and
a brake backer plate attached to said wheelend adapter.

16. The wheelend as defined in claim 15, wherein said spindle member is formed integrally with said brake backer plate as a homogenous, unitary single-piece part.

17. The wheelend as defined in claim 15, wherein said wheelend adapter is formed integrally with said spindle member as a homogenous, unitary single-piece part.

18. The wheelend as defined in claim 15, wherein said cylindrical bearing support surface is an inner peripheral surface of said spindle member; and wherein said axle bearing is mounted within said tubular spindle member.

19. The wheelend as defined in claim 15, wherein said cylindrical bearing support surface is an outer peripheral surface of said spindle member, and wherein said axle bearing is mounted outside said spindle member.

20. A method for manufacturing a banjo-type axle housing assembly for a motor vehicle, said housing assembly including a hollow axle housing having a central section and a pair of axle arm sections axially oppositely extending from said central section along a center axis of said axle housing, said method including the steps of:
(a) selecting a desired length of said axle housing;
(b) producing said axle housing having a length larger than said desired length;
(c) selectively trimming outboard end portions of said axle arm sections of said axle housing to a degree so that more than burrs or flash material is removed so as to achieve said desired length.

21. The method for manufacturing the axle housing assembly as defined in claim 20, wherein the step of selecting said desired length of said axle housing includes the steps of selecting desired lengths of said axle arm sections of said axle housing.

22. The method for manufacturing the axle housing assembly as defined in claim 21, wherein said desired lengths of said axle arm sections of said axle housing are equal to each other.

23. The method for manufacturing the axle housing assembly as defined in claim 21, wherein said desired lengths of said axle arm sections of said axle housing differ from each other.

24. The method for manufacturing the axle housing assembly as defined in claim 20, wherein said outboard end portions of said arm sections have substantially rectangular cross-section.

25. The method for manufacturing the axle housing assembly as defined in claim 20, wherein the step of manufacturing said axle housing includes the steps of:
(a) forming first and second elongated axle housing half members each having a substantially U-shaped cross-section along entire length thereof; and
(b) fixing said housing half members to each other to produce said axle housing.

26. The method for manufacturing the axle housing assembly as defined in claim 20, further including the step of fixing wheelend units to corresponding outboard end portions of said axle housing.

27. The method for manufacturing the axle housing assembly as defined in claim 26, wherein each of said wheelend units includes:
a wheelend adapter;
a tubular spindle member extending axially outwardly from said wheelend adapter and having a substantially cylindrical bearing support surface for supporting an axle bearing; and
a brake backer plate attached to said wheelend adapter.

28. The method for manufacturing the axle housing assembly as defined in claim 27, wherein the step of fixing said wheelend units includes the steps of fixing said wheelend adapter to said outboard end of said arm section so that an inboard face of said wheelend adapter engages an end face of said outboard end of said arm section of said axle housing assembly.

29. The method for manufacturing the axle housing assembly as defined in claim 28, wherein said wheelend adapter is fixed to said outboard end portion of said arm section so as to extend radially inwardly from a wall of said arm section of said axle housing assembly.

30. The method for manufacturing the axle housing assembly as defined in claim 27, wherein said cylindrical bearing support surface is an inner peripheral surface of said spindle member.

31. The method for manufacturing the axle housing assembly as defined in claim 27, wherein said cylindrical bearing support surface is an outer peripheral surface of said spindle member.

32. The method for manufacturing the axle housing assembly as defined in claim 27, wherein said wheelend adapter is fixed to said outboard end portion of said arm section substantially coaxially to said center axis and is oriented substantially perpendicularly to said center axis.

33. The method for manufacturing the axle housing assembly as defined in claim 27, wherein said brake backer plate is attached to said wheelend adapter by means of a plurality of threaded fasteners.

34. The method for manufacturing the axle housing assembly as defined in claim 27, further comprising a wheel brake mechanism fastened to said brake backer plate.

35. The method for manufacturing the axle housing assembly as defined in claim 27, wherein said wheelend adapter is annular in shape and has a central opening therethrough.
